(19) United States
(12) Patent Application Publication
(10) Pub. No.: US 2024/0011755 A1
(43) Pub. Date: Jan. 11, 2024

(54) POSITION DETECTION DEVICE

(71) Applicant: Panasonic Intellectual Property Management Co., Ltd., Osaka (JP)

(72) Inventors: Keisuke GOUDA, Fukui (JP); Seigo YAMANAKA, Gifu (JP)

(21) Appl. No.: 18/471,091

(22) Filed: Sep. 20, 2023

Related U.S. Application Data
(63) Continuation of application No. PCT/JP2021/042360, filed on Nov. 18, 2021.

(30) Foreign Application Priority Data
Mar. 24, 2021 (JP) 2021-049763

(51) Int. Cl. G01B 7/00

(52) U.S. Cl. CPC G01B 7/003

(57) ABSTRACT

A position detection device includes a magnet and first to ninth magnetic sensors. The first to ninth magnetic sensors include first to third magnetic sensors. An output of each of the first to third magnetic sensors switches when a shift lever shifts between position M and position N. Switching of outputs of the first and third magnetic sensors among the first to third magnetic sensors and switching of an output of the second magnetic sensor which is a remaining one of the first to third magnetic sensors are inverted when the shift lever shifts between position M and position N.

### CROSS REFERENCE TO RELATED APPLICATIONS

This is a continuation application of PCT International Application No. PCT/JP2021/042360 filed on Nov. 18, 2021, designating the United States of America, which is based on and claims priority of Japanese Patent Application No. 2021-049763 filed on Mar. 24, 2021.

### FIELD

The present disclosure relates to a position detection device.

### BACKGROUND

Position sensors including a magnet and six detection elements have been disclosed conventionally (see, for example, Patent Literature (PTL) 1). In addition, position detection devices provided with a detection system which includes a detection object, three first detectors, three second detectors, and three third detectors have been disclosed (see, for example, PTL 2).

### CITATION LIST

### Patent Literature

PTL 1: Japanese Unexamined Patent Application Publication No. 2017-45190
PTL 2: Japanese Unexamined Patent Application Publication No. 2020-52037

### SUMMARY

However, the above-described position sensor according to PTL 1 and the above-described position detection device according to PTL 2 can be improved upon.

In view of this, the present disclosure provides a position detection device which is capable of improving upon the above related art.

A position detection device according to one aspect of the present disclosure is a position detection device that detects a position of an operable portion that is shiftable: from a first position to a second position and a third position located in two mutually different directions; and from the second position to the first position, a fourth position, and a fifth position located in three mutually different directions. The position detection device includes: a detection object; and a plurality of detectors each of which outputs a first type of signal or a second type of signal according to a positional relationship with the detection object. In the position detection device, according to shifting of the operable portion: the detection object shifts with respect to the plurality of detectors; the plurality of detectors shift with respect to the detection object; or the detection object shifts with respect to the plurality of detectors and the plurality of detectors shift with respect to the detection object, the plurality of detectors include: three first detectors; three second detectors; and three third detectors, an output of each of the three first detectors switches when the operable portion shifts between the first position and the second position, an output of each of the three second detectors switches when the operable portion shifts between the first position and the third position or between the second position and the fourth position, and an output of each of the three third detectors switches when the operable portion shifts between the second position and the fifth position, and at least one of the following (i) to (iii) is satisfied: (i) switching of outputs of two of the three first detectors and switching of an output of a remaining one of the three first detectors are inverted when the operable portion shifts between the first position and the second position; (ii) switching of outputs of two of the three second detectors and switching of an output of a remaining one of the three second detectors are inverted when the operable portion shifts between the first position and the third position or between the second position and the fourth position; and (iii) switching of outputs of two of the three third detectors and switching of an output of a remaining one of the three third detectors are inverted when the operable portion shifts between the second position and the fifth position.

The position detection device according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view illustrating a shifting device provided with a position detection device according to an embodiment.

FIG. 2 is a block diagram illustrating a functional configuration of the position detection device illustrated in FIG. 1.

FIG. 3 is a diagram schematically illustrating the position detection device illustrated in FIG. 1.

FIG. 4 is a diagram schematically illustrating the relative positions of a detection object of the position detection device illustrated in FIG. 1 and a plurality of detectors when an operable portion is located in the respective positions.

FIG. 5 is a table indicating the signals output by the plurality of detectors of the position detection device illustrated in FIG. 1 when the operable portion is located in the respective positions.

FIG. 6 is a table indicating hamming distances between a plurality of positions.

FIG. 7 is a table indicating the signals that can be output by the plurality of detectors of the position detection device illustrated in FIG. 1 when the operable portion is positioned somewhere in between the first position and the third position, and is positioned somewhere in between the first position and the sixth position.

FIG. 8 is a table indicating the signals that can be output by the plurality of detectors of the position detection device illustrated in FIG. 1 when the operable portion is positioned somewhere in between the first position and the second position.

FIG. 9 is a table indicating the signals that can be output by the plurality of detectors of the position detection device illustrated in FIG. 1 when the operable portion is positioned somewhere in between the second position and the fourth position, and is positioned somewhere in between the second position and the fifth position.

FIG. 10 is a diagram schematically illustrating another example of the position detection device.

### DESCRIPTION OF EMBODIMENTS

### Underlying Knowledge Forming Basis of the Present Disclosure

The inventors found the occurrence of the following in relation to the position sensor according to PTL 1 and the position detection device according to PTL 2 described in the “Background” section.

With the above-described position sensor according to PTL 1, false detection may occur as a result of the ON/OFF combination of the six detection elements becoming the same among different positions. Furthermore, with the above-described position detection device according to PTL 2, the three first detectors are arranged such that the switching does not invert but coincide among the three first detectors, and are aligned in one direction. As a result, the detection object tends to be large in the one direction. The same holds true for the three second detectors and the three third detectors. As described above, with the above-described position detection device according to PTL 2, the detection object tends to be large, making it difficult to downsize the position detection device.

In view of the above, the present disclosure provides a position detection device that can inhibit the occurrence of false detections and is easy to downsize.

Hereinafter, embodiments will be described in detail with reference to the Drawings.

It should be noted that the embodiments described below each show a general or specific example. The numerical values, shapes, materials, structural components, the arrangement and connection of the structural components, steps, the processing order of the steps, etc. presented in the following embodiments are mere examples, and therefore do not limit the present disclosure. In addition, among the structural components in the following embodiments, structural components not recited in any one of the independent claims are described as arbitrary structural elements.

In addition, each diagram is a schematic diagram and not necessarily strictly illustrated. Furthermore, in the respective figures, the same numerical sign is given to identical structural components.

### Embodiment

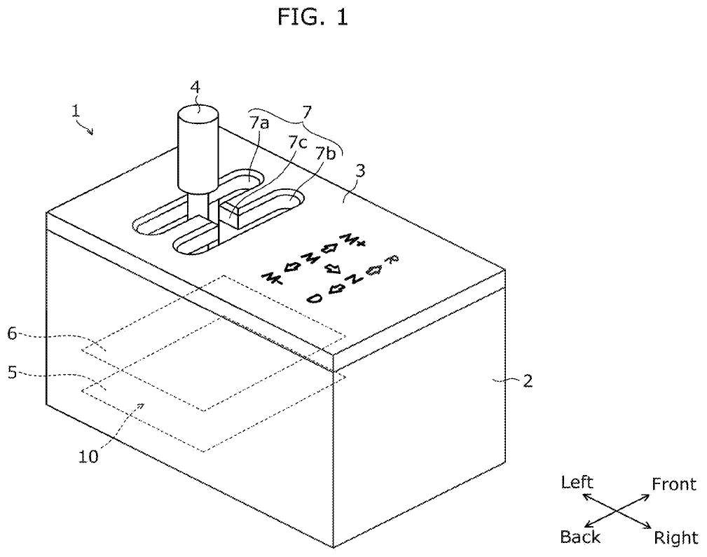

FIG. 1 is a perspective view illustrating shifting device 1 provided with position detection device 10 according to an embodiment.

As illustrated in FIG. 1, for example, shifting device 1 is a device that is provided in a vehicle such as an automobile, and receives an operation performed by a driver of the vehicle. More specifically, for example, shifting device 1 receives an operation to control the transmission of the vehicle. It should be noted that, in the following description, the front-back direction refers to the front-back direction of the vehicle in which shifting device 1 is provided, the right-left direction refers to the right-left direction of the vehicle in which shifting device 1 is provided, and the up-down direction refers to the direction perpendicular to the front-back direction and perpendicular to the right-left direction. Shifting device 1 includes: housing 2; shift panel 3; shift lever 4; substrate 5, support 6; and position detection device 10. In the present embodiment, shift lever 4 corresponds to an operable portion that is shiftable: from the first position to the second position and the third position located in two mutually different directions; and from the second position to the first position, the fourth position, and the fifth position located in three mutually different directions.

Housing 2 is a housing that houses position detection device 10, etc. For example, housing 2 is fixed to the vehicle. Shift panel 3 is attached to housing 2. Guide groove 7 is defined in shift panel 3. Guide groove 7 restricts the direction of movement of shift lever 4.

Guide groove 7 penetrates through shift panel 3. Guide groove 7 includes left groove 7a, right groove 7b, and center groove 7c. Left groove 7a extends in the front-back direction. Right groove 7b is located to the right of left groove 7a in the right-left direction, and extends in parallel with left groove 7a. Center groove 7c extends in the right-left direction, is connected to the center portions, in the front-back direction, of left groove 7a and right groove 7b, and communicates with left groove 7a and right groove 7b. As described above, in this embodiment, guide groove 7 is defined in an H-shape when viewed in the up-down direction, and shifting device 1 is a so-called H-shaped shifting device.

Shift lever 4 is shiftable from position M to position N and position M− which are located in two directions different from each other, and is shiftable from position N to position M, position D, and position R which are located in three directions different from one another. In addition, shift lever 4 is shiftable from position M to position M+ which is located in a direction different from position N and position M−. In this embodiment, position M corresponds to the first position, position N corresponds to the second position, position M− corresponds to the third position, position D corresponds to the fourth position, position R corresponds to the fifth position, and position M+ corresponds to the sixth position.

Position M is a position located at the center portion of left groove 7a in the front-back direction, and position N is a position located at the center portion of right groove 7b in the front-back direction and to the right of position M. In other words, in this embodiment, the front-back direction corresponds to a perpendicular direction that is perpendicular to the direction from the first position to the second position, and the right-left direction corresponds to a parallel direction that is parallel to the direction from the first position to the second position.

Position M− is a position located at the back end of left groove 7a and behind position M. Position D is a position located at the back end of right groove 7b and behind position N. In other words, in this embodiment, the direction from position M to position M− and the direction from position N to position D are the same direction as each other and parallel to the front-back direction.

Position R is a position located at the front end of right groove 7b and in front of position N. Position M+ is a position located at the front end of left groove 7a and in front of position M. In other words, in this embodiment, the direction from position N to position R and the direction from position M to position M+ are the same direction as each other and parallel to the front-back direction. In addition, in this embodiment, the direction from position N to position R is opposite to the direction from position N to position D, and the direction from position M to the position M+ is opposite to the direction from position M to position M−.

Shift lever 4 is movable along guide groove 7, and the driver who is driving the vehicle can cause shift lever 4 to shift to any one of six positions, namely, position M, position N, position M−, position D, position R, and position M+, by moving shift lever 4 along guide groove 7.

Substrate 5 and support 6 are disposed in housing 2. Support 6 is located above substrate 5. Support 6 is attached to the lower end portion of shift lever 4 and shifts with respect to substrate 5 according to the shifting of shift lever 4.

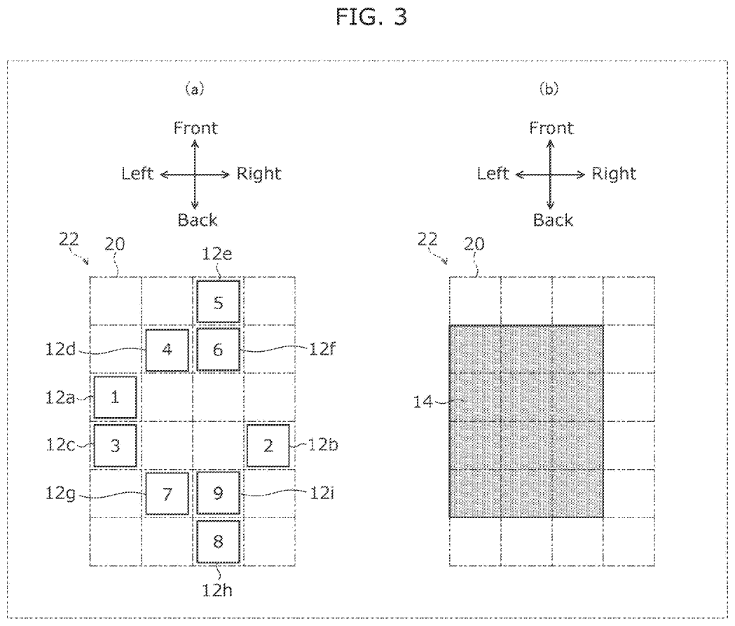

Position detection device 10 is a position detection device that detects a position of shift lever 4. Position detection device 10 includes: first to ninth magnetic sensors 12a to 12i (see FIG. 3) disposed on substrate 5; and magnet 14 (see FIG. 3) disposed on support 6. In this embodiment, magnet 14 corresponds to a detection object, and first to ninth magnetic sensors 12a to 12i are respectively correspond to a plurality of detectors each of which outputs a first type of signal or a second type of signal according to a positional relationship with the detection object.

Magnet 14 shifts with respect to first to ninth magnetic sensors 12a to 12i according to the shifting of shift lever 4. Each of first to ninth magnetic sensors 12a to 12i outputs a first type of signal or a second type of signal according to the positional relationship with magnet 14. It is possible to detect the position of shift lever 4 based on a combination of signals output by first to ninth magnetic sensors 12a to 12i. The details will be given later.

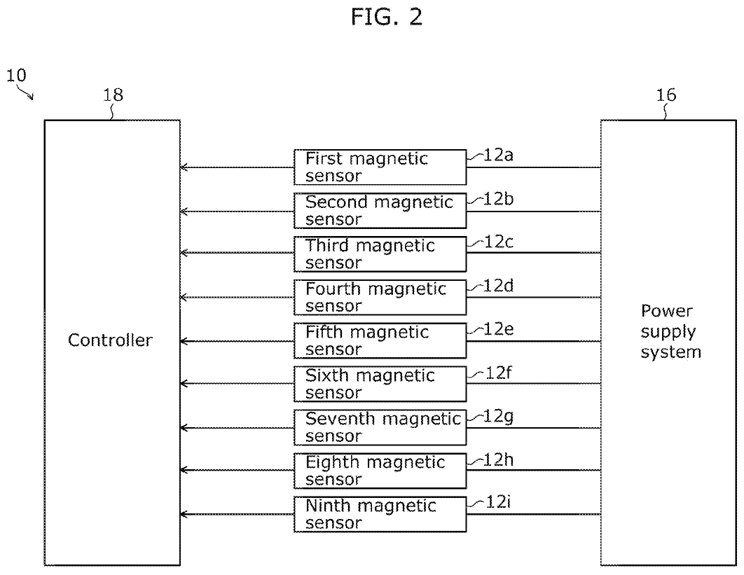

FIG. 2 is a block diagram illustrating the functional configuration of position detection device 10 illustrated in FIG. 1.

As illustrated in FIG. 2, position detection device 10 further includes power supply system 16 and controller 18.

As described above, each of first to ninth magnetic sensors 12a to 12i outputs a first type of signal or a second type of signal according to the positional relationship with magnet 14. In this embodiment, first to ninth magnetic sensors 12a to 12i each output an ON signal when facing magnet 14 in the up-down direction and outputs an OFF signal when not facing magnet 14 in the up-down direction. First to ninth magnetic sensors 12a to 12i include first to third magnetic sensors 12a to 12c, fourth, sixth, and eighth magnetic sensors 12d, 12f, and 12h, and fifth, seventh, and ninth magnetic sensors 12e, 12g, and 12i.

In this embodiment, first to third magnetic sensors 12a to 12c correspond to three first detectors. An output of each of the three first detectors switches when the operable portion shifts between the first position and the second position. Fourth, sixth, and eighth magnetic sensors 12d, 12f, and 12h correspond to three second detectors. An output of each of the three second detectors switches when the operable portion shifts between the first position and the third position or between the second position and the fourth position. Fifth, seventh, and ninth magnetic sensors 12e, 12g, and 12i correspond to three third detectors. An output of each of the three third detectors switches when the operable portion shifts between the second position and the fifth position.

First to third magnetic sensors 12a to 12c are each arranged such that the output switches when shift lever 4 shifts between position M and position N. In other words, the output of each of first to third magnetic sensors 12a to 12c switches when shift lever 4 shifts from position M to position N or when shift lever 4 shifts from position N to position M.

Fourth, sixth, and eighth magnetic sensors 12d, 12f, and 12h are each arranged such that the output switches when shift lever 4 shifts between position M and position M−. In other words, the output of each of fourth, sixth, and eighth magnetic sensors 12d, 12f, and 12h switches when shift lever 4 shifts from position M to position M− or when shift lever 4 shifts from position M− to position M.

Moreover, fourth, sixth, and eighth magnetic sensors 12d, 12f, and 12h are each arranged such that the output switches when shift lever 4 shifts between position N and position D. In other words, the output of each of fourth, sixth, and eighth magnetic sensors 12d, 12f, and 12h switches when shift lever 4 shifts from position N to position D or when shift lever 4 shifts from position D to position N.

Fifth, seventh, and ninth magnetic sensors 12e, 12g, and 12i are each arranged such that the output switches when shift lever 4 shifts between position N and position R. In other words, the output of each of fifth, seventh, and ninth magnetic sensors 12e, 12g, and 12i switches when shift lever 4 shifts from position N to position R or when shift lever 4 shifts from position R to position N.

Moreover, fifth, seventh, and ninth magnetic sensors 12e, 12g, and 12i are each arranged such that the output switches when shift lever 4 shifts between position M and position M+. In other words, the output of each of fifth, seventh, and ninth magnetic sensors 12e, 12g, and 12i switches when shift lever 4 shifts from position M to position M+ or when shift lever 4 shifts from position M+ to position M.

Power supply system 16 supplies power to first to ninth magnetic sensors 12a to 12i. Controller 18 obtains the signals output by first to ninth magnetic sensors 12a to 12i, and determines the position of shift lever 4 based on the signals output by first to ninth magnetic sensors 12a to 12i. For example, controller 18 drives a transmission (not illustrated) based on the position of shift lever 4.

FIG. 3 is a diagram schematically illustrating position detection device 10 illustrated in FIG. 1. In FIG. 3, (a) is a diagram illustrating first to ninth magnetic sensors 12a to 12i provided on substrate 5 viewed from above, and (b) is a diagram illustrating magnet 14 provided on support 6 viewed from above.

As illustrated in (a) in FIG. 3, among first to third magnetic sensors 12a to 12c, first magnetic sensor 12a and third magnetic sensor 12c are disposed side by side in the front-back direction. Third magnetic sensor 12c is disposed behind first magnetic sensor 12a.

For example, when assuming matrix 22 in which a plurality of unit regions 20 are arranged in the front-back direction and right-left direction, first magnetic sensor 12a is disposed in one unit region 20 among the plurality of unit regions 20, and third magnetic sensor 12c is disposed in unit region 20 adjacent, in the front-back direction, to unit region 20 where first magnetic sensor 12a is disposed.

Second magnetic sensor 12b among first to third magnetic sensors 12a to 12c is disposed at a position different from first magnetic sensor 12a and third magnetic sensor 12c in the right-left direction. In other words, second magnetic sensor 12b is not disposed side by side with first magnetic sensor 12a and third magnetic sensor 12c in the front-back direction. Second magnetic sensor 12b is aligned with one of first magnetic sensor 12a and third magnetic sensor 12c in the right-left direction. In this embodiment, second magnetic sensor 12b is aligned with third magnetic sensor 12c in the right-left direction. In this embodiment, second magnetic sensor 12b is aligned with third magnetic sensor 12c in the right-left direction, with a space therebetween corresponding to two magnetic sensors each having the same size as each of the first to ninth magnetic sensors 12a to 12i. It should be noted that second magnetic sensor 12b may be aligned with first magnetic sensor 12a in the right-left direction.

For example, when assuming matrix 22, second magnetic sensor 12b is disposed, among the plurality of unit regions 20, in unit region 20 which is located adjacent, in the right-left direction, to unit region 20 in which third magnetic sensor 12c is disposed, with two unit regions 20 disposed therebetween.

Fourth, sixth, and eighth magnetic sensors 12d, 12f, and 12h are disposed closer to second magnetic sensor 12b than first magnetic sensor 12a and third magnetic sensor 12c are, and closer to first magnetic sensor 12a and third magnetic sensor 12c than second magnetic sensor 12b is, in the right-left direction. In other words, fourth, sixth, and eighth magnetic sensors 12d, 12f, and 12h are located to the right of first magnetic sensor 12a and third magnetic sensor 12c and to the left of second magnetic sensor 12b.

For example, when assuming matrix 22, fourth, sixth, and eighth magnetic sensors 12d, 12f, and 12h are disposed in, among the plurality of unit regions 20, three of unit regions 20 that are located closer to second magnetic sensor 12b than unit region 20 in which first magnetic sensor 12a is disposed and unit region 20 in which third magnetic sensor 12c is disposed are, and are located closer to first magnetic sensor 12a and third magnetic sensor 12c than unit region 20 in which second magnetic sensor 12b is disposed is.

Fourth magnetic sensor 12d and sixth magnetic sensor 12f among fourth, sixth, and eighth magnetic sensors 12d, 12f, and 12h are disposed side by side in the right-left direction. Sixth magnetic sensor 12f is located to the right of fourth magnetic sensor 12d.

For example, when assuming matrix 22, fourth magnetic sensor 12d is disposed in one unit region 20 among the plurality of unit regions 20, and sixth magnetic sensor 12f is dispose in unit region 20 adjacent in the right-left direction with unit region 20 in which fourth magnetic sensor 12d is disposed.

Eighth magnetic sensor 12h among fourth, sixth, and eighth magnetic sensors 12d, 12f, and 12h is disposed at a position different from fourth magnetic sensor 12d and sixth magnetic sensor 12f in the front-back direction. In other words, eighth magnetic sensor 12h is not aligned with fourth magnetic sensor 12d and sixth magnetic sensor 12f in the right-left direction. Eighth magnetic sensor 12h is aligned with one of fourth magnetic sensor 12d and sixth magnetic sensor 12f in the front-back direction. In this embodiment, eighth magnetic sensor 12h is aligned with sixth magnetic sensor 12f in the front-back direction. In this embodiment, eighth magnetic sensor 12h is aligned with sixth magnetic sensor 12f in the front-back direction, with a space therebetween corresponding to three magnetic sensors each having the same size as each of the first to ninth magnetic sensors 12a to 12i. It should be noted that eighth magnetic sensor 12h may be aligned with fourth magnetic sensor 12d in the front-back direction.

For example, when assuming matrix 22, eighth magnetic sensor 12h is disposed in, among the plurality of unit regions 20, unit region 20 which is located adjacent, in the front-back direction, to unit region 20 in which sixth magnetic sensor 12f is disposed, with three unit regions 20 disposed therebetween.

First to third magnetic sensors 12a to 12c are located closer to eighth magnetic sensor 12h than fourth magnetic sensor 12d and sixth magnetic sensor 12f are, and closer to fourth magnetic sensor 12d and sixth magnetic sensor 12f than eighth magnetic sensor 12h is, in the front-back direction. In other words, first to third magnetic sensors 12a to 12c are located behind fourth magnetic sensor 12d and sixth magnetic sensor 12f, and located forward of eighth magnetic sensor 12h.

For example, when assuming matrix 22, first to third magnetic sensors 12a to 12c are disposed in, among the plurality of unit regions 20, three of unit regions 20 which are located closer to eighth magnetic sensor 12h than unit region 20 in which fourth magnetic sensor 12d is disposed and unit region 20 in which sixth magnetic sensor 12f is disposed are, and closer to fourth magnetic sensor 12d and sixth magnetic sensor 12f than unit region 20 in which eighth magnetic sensor 12h is disposed is.

Fifth, seventh, and ninth magnetic sensors 12e, 12g, and 12i are disposed closer to second magnetic sensor 12b than first magnetic sensor 12a and third magnetic sensor 12c are, and closer to first magnetic sensor 12a and third magnetic sensor 12c than second magnetic sensor 12b is, in the right-left direction. In other words, fifth, seventh, and ninth magnetic sensors 12e, 12g, and 12i are located to the right of first magnetic sensor 12a and third magnetic sensor 12c and to the left of second magnetic sensor 12b.

For example, when assuming matrix 22, fifth, seventh, and ninth magnetic sensors 12e, 12g, and 12i are disposed in, among the plurality of unit regions 20, three of unit regions 20 which are located closer to second magnetic sensor 12b than unit region 20 in which first magnetic sensor 12a is disposed and unit region 20 in which third magnetic sensor 12c is disposed are, and closer to first magnetic sensor 12a and third magnetic sensor 12c than unit region 20 in which second magnetic sensor 12b is disposed is.

Seventh magnetic sensor 12g and ninth magnetic sensor 12i among fifth, seventh, and ninth magnetic sensors 12e, 12g, and 12i are disposed side by side in the right-left direction. Ninth magnetic sensor 12i is located to the right of seventh magnetic sensor 12g.

For example, when assuming matrix 22, seventh magnetic sensor 12g is disposed in one unit region 20 among the plurality of unit regions 20, and ninth magnetic sensor 12i is dispose in unit region 20 adjacent in the right-left direction with unit region 20 in which seventh magnetic sensor 12g is disposed.

In addition, in front-back direction, seventh magnetic sensor 12g is aligned with fourth magnetic sensor 12d, and ninth magnetic sensor 12i is aligned with six magnetic sensor 12f. In this embodiment, seventh magnetic sensor 12g is aligned with fourth magnetic sensor 12d in the front-back direction, with a space therebetween corresponding to two magnetic sensors each having the same size as each of the first to ninth magnetic sensors 12a to 12i. In addition, ninth magnetic sensor 12i is aligned with sixth magnetic sensor 12f in the front-back direction, with a space therebetween corresponding to two magnetic sensors each having the same size as each of the first to ninth magnetic sensors 12a to 12i.

For example, when assuming matrix 22, among the plurality of unit regions 20, seventh magnetic sensor 12g is disposed in unit region 20 which is located adjacent, in the front-back direction, to unit region 20 in which fourth magnetic sensor 12d is disposed, with two unit regions 20 disposed therebetween, and ninth magnetic sensor 12i is disposed in unit region 20 which is located adjacent, in the front-back direction, to unit region 20 in which sixth magnetic sensor 12f is disposed, with two unit regions 20 disposed therebetween.

Fifth magnetic sensor 12e among fifth, seventh, and ninth magnetic sensors 12e, 12g, and 12i is disposed at a position different from seventh magnetic sensor 12g and ninth magnetic sensor 12i in the front-back direction. In other words, fifth magnetic sensor 12e is not aligned with seventh magnetic sensor 12g and ninth magnetic sensor 12i in the right-left direction. Fifth magnetic sensor 12e is aligned with one of fourth magnetic sensor 12d and sixth magnetic sensor 12f, one of seventh magnetic sensor 12g and ninth magnetic sensor 12i, and eighth magnetic sensor 12h, in the front-back direction. In this embodiment, fifth magnetic sensor 12e is aligned with sixth magnetic sensor 12f, ninth magnetic sensor 12i, and eighth magnetic sensor 12h in the front-back direction. It should be noted that fifth magnetic sensor 12e may be aligned with fourth magnetic sensor 12d in the front-back direction.

For example, when assuming matrix 22, among the plurality of unit regions 20, fifth magnetic sensor 12e is disposed in unit region 20 which: is aligned, in the front-back direction, with unit region 20 in which sixth magnetic sensor 12f is disposed, unit region 20 in which ninth magnetic sensor 12i is disposed, and unit region 20 in which eighth magnetic sensor 12h is disposed; and is aligned, in the front-back direction, with unit region 20 in which ninth magnetic sensor 12i is disposed, with three unit regions 20 disposed therebetween.

In other words, sixth magnetic sensor 12f is disposed between fifth magnetic sensor 12e and ninth magnetic sensor 12i. More specifically, at least one of the three second detectors (fourth, sixth, and eighth magnetic sensors 12d, 12f, and 12h) is disposed between the three detectors (fifth, seventh, and ninth magnetic sensors 12e, 12g, and 12i) in the front-back direction.

In addition, ninth magnetic sensor 12i is disposed between sixth magnetic sensor 12f and eighth magnetic sensor 12h. In other words, at least one of the three third detectors is disposed between the three second detectors in the front-back direction.

First to third magnetic sensors 12a to 12c are located closer to fifth magnetic sensor 12e than seventh magnetic sensor 12g and ninth magnetic sensor 12i are, and closer to seventh magnetic sensor 12g and ninth magnetic sensor 12i than fifth magnetic sensor 12e is, in the front-back direction. In other words, first to third magnetic sensors 12a to 12c are located forward of seventh magnetic sensor 12g and ninth magnetic sensor 12i, and located behind fifth magnetic sensor 12e.

For example, when assuming matrix 22, among the plurality of unit regions 20, first to third magnetic sensors 12a to 12c are disposed in three of unit regions 20 which: are located closer to fifth magnetic sensor 12e than unit region 20 in which seventh magnetic sensor 12g is disposed and unit region 20 in which ninth magnetic sensor 12i is disposed are; and are located closer to seventh magnetic sensor 12g and ninth magnetic sensor 12i than unit region 20 in which fifth magnetic sensor 12e is disposed is.

More specifically, first to third magnetic sensors 12a to 12c are disposed in three of unit regions 20 which: are located closer to fifth magnetic sensor 12e than the third detectors (seventh and ninth magnetic sensors 12g and 12i in FIG. 3) located between the three second detectors (fourth, sixth, and eighth magnetic sensors 12d, 12f, and 12h) are in the front-back direction; and are located closer to eighth magnetic sensor 12h than the second detectors (fourth and sixth magnetic sensors 12d and 12f in FIG. 3) located between the three third detectors (fifth, seventh, and ninth magnetic sensors 12e, 12g, and 12i) are in the front-back direction.

As illustrated in (b) in FIG. 3, magnet 14 has a quadrilateral shape with the longitudinal direction being the front-back direction and the short-side direction being the right-left direction when viewed from above, and is disposed to face any of first to ninth magnetic sensors 12a to 12i. For example, when assuming matrix 22, the size of magnet 14 in the front-back direction is equal to the size of a total of four unit regions 20, and the size of magnet 14 in the right-left direction is equal to the size of a total of three unit regions 20. In this embodiment, magnet 14 is magnetized such that the surface of magnet 14 facing first to ninth magnetic sensors 12a to 12i is S-pole.

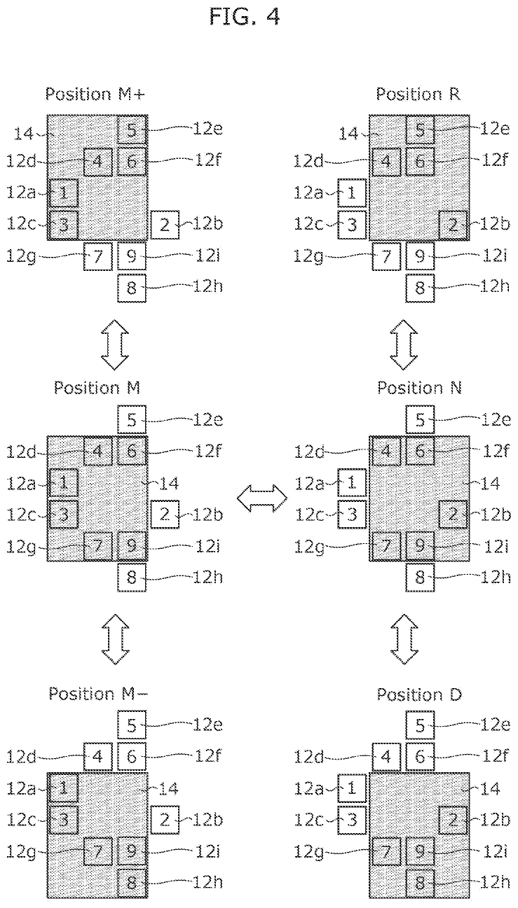

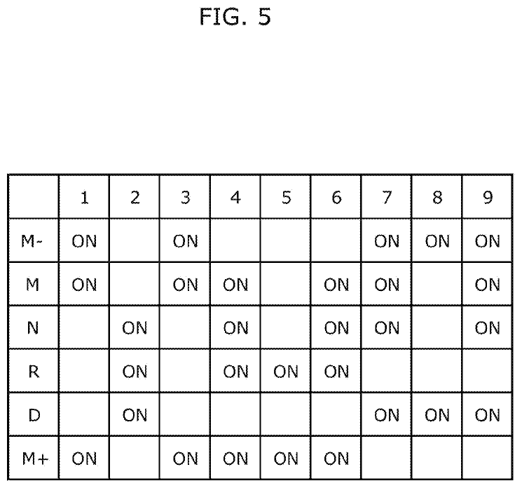

FIG. 4 is a diagram schematically illustrating the relative positions of magnet 14 and first to ninth magnetic sensors 12a to 12i of position detection device 10 illustrated in FIG. 1 when shift lever 4 is located in the respective positions. FIG. 5 is a table indicating the signals output by first to ninth magnetic sensors 12a to 12i of position detection device 10 illustrated in FIG. 1 when shift lever 4 is located in the respective positions. It should be noted that OFF signals are omitted in FIG. 5.

As illustrated in FIG. 4 and FIG. 5, first to third magnetic sensors 12a to 12c are arranged such that, among first to third magnetic sensors 12a to 12c, the switching of the output of each of first magnetic sensor 12a and third magnetic sensor 12c and the switching of the output of second magnetic sensor 12b are inverted when shift lever 4 shifts between position M and position N.

For example, when shift lever 4 is in position M, first magnetic sensor 12a and third magnetic sensor 12c face magnet 14, and second magnetic sensor 12b does not face magnet 14. Accordingly, at this time, first magnetic sensor 12a and third magnetic sensor 12c each output an ON signal, and second magnetic sensor 12b outputs an OFF signal. On the other hand, when shift lever 4 is in position N, first magnetic sensor 12a and third magnetic sensor 12c do not face magnet 14 and second magnetic sensor 12b faces magnet 14. Accordingly, at this time, first magnetic sensor 12a and third magnetic sensor 12c each output an OFF signal, and second magnetic sensor 12b outputs an ON signal.

In other words, when shift lever 4 shifts from position M to position N, the output of each of first magnetic sensor 12a and third magnetic sensor 12c switches from an ON signal to an OFF signal, and the output of second magnetic sensor 12b switches from an OFF signal to an ON signal. As described above, when shift lever 4 shifts from position M to position N, the switching of the output of each of first magnetic sensor 12a and third magnetic sensor 12c and the switching of the output of second magnetic sensor 12b are inverted.

In addition, when shift lever 4 shifts from position N to position M, the output of each of first magnetic sensor 12a and third magnetic sensor 12c switches from an OFF signal to an ON signal, and the output of second magnetic sensor 12b switches from an ON signal to an OFF signal. In this manner, when shift lever 4 shifts from position N to position M, the switching of the output of each of first magnetic sensor 12a and third magnetic sensor 12c and the switching of the output of second magnetic sensor 12b are inverted.

It should be noted that, when shift lever 4 is in position M or in position N, each of fourth, sixth, seventh, and ninth magnetic sensors 12d, 12f, 12g, and 12i faces magnet 14 and outputs an ON signal. In other words, when shift lever 4 shifts between position M and position N, the outputs of fourth, sixth, seventh, and ninth magnetic sensors 12d, 12f, 12g, and 12i do not switch.

In addition, when shift lever 4 is in position M or in position N, each of fifth and eighth magnetic sensors 12e and 12h does not face magnet 14 and outputs an OFF signal. In other words, when shift lever 4 shifts between position M and position N, the outputs of fifth and eighth magnetic sensors 12e and 12h do not switch.

Fourth, sixth, and eighth magnetic sensors 12d, 12f, and 12h are arranged such that, among fourth, sixth, and eighth magnetic sensors 12d, 12f, and 12h, the switching of the output of each of fourth magnetic sensor 12d and sixth magnetic sensor 12f and the switching of the output of eighth magnetic sensor 12h are inverted when shift lever 4 shifts between position M and position M− or shifts between position N and position D.

For example, when shift lever 4 is in position M or in position N, fourth magnetic sensor 12d and sixth magnetic sensor 12f face magnet 14, and eighth magnetic sensor 12h does not face magnet 14. Accordingly, at this time, fourth magnetic sensor 12d and sixth magnetic sensor 12f each output an ON signal, and eighth magnetic sensor 12h outputs an OFF signal. On the other hand, when shift lever 4 is in position M− or in position D, fourth magnetic sensor 12d and sixth magnetic sensor 12f do not face magnet 14 and eighth magnetic sensor 12h faces magnet 14. Accordingly, at this time, fourth magnetic sensor 12d and sixth magnetic sensor 12f each output an OFF signal, and eighth magnetic sensor 12h outputs an ON signal.

In other words, when shift lever 4 shifts from position M to position M− or shifts from position N to position D, the output of each of fourth magnetic sensor 12d and sixth magnetic sensor 12f switches from an ON signal to an OFF signal, and the output of eighth magnetic sensor 12h switches from an OFF signal to an ON signal. As described above, when shift lever 4 shifts from position M to position M− or shifts from position N to position D, the switching of the output of each of fourth magnetic sensor 12d and sixth magnetic sensor 12f and the switching of the output of eighth magnetic sensor 12h are inverted.

In addition, when shift lever 4 shifts from position M− to position M and shifts from position D to position N, the output of each of fourth magnetic sensor 12d and sixth magnetic sensor 12f switches from an OFF signal to an ON signal, and the output of eighth magnetic sensor 12h switches from an ON signal to an OFF signal. As described above, when shift lever 4 shifts from position M− to position M and shifts from position D to position N, the switching of the output of each of fourth magnetic sensor 12d and sixth magnetic sensor 12f and the switching of the output of eighth magnetic sensor 12h are inverted.

It should be noted that, when shift lever 4 is in position M or in position M−, first, third, seventh, and ninth magnetic sensors 12a, 12c, 12g, and 12i face magnet 14, and each output an ON signal. In other words, when shift lever 4 shifts between position M and position M−, the outputs of first, third, seventh, and ninth magnetic sensors 12a, 12c, 12g, and 12i do not switch.

In addition, when shift lever 4 is in position M or in position M−, second and fifth magnetic sensors 12b and 12e do not face magnet 14, and each output an OFF signal. In other words, when shift lever 4 shifts between position M and position M−, the outputs of second and fifth magnetic sensors 12b and 12e do not switch.

In addition, when shift lever 4 is in position N or in position D, second, seventh, and ninth magnetic sensors 12b, 12g, and 12i face magnet 14, and each output an ON signal. In other words, when shift lever 4 shifts between position N and position D, the outputs of second, seventh, and ninth magnetic sensors 12b, 12g, and 12i do not switch.

In addition, when shift lever 4 is in position N or in position D, first, third, and fifth magnetic sensors 12a, 12c, and 12e do not face magnet 14, and each output an OFF signal. In other words, when shift lever 4 shifts between position N and position D, the outputs of first, third, and fifth magnetic sensors 12a, 12c, and 12e do not switch.

Fifth, seventh, and ninth magnetic sensors 12e, 12g, and 12i are arranged such that, among fifth, seventh, and ninth magnetic sensors 12e, 12g, and 12i, the switching of the output of each of seventh magnetic sensor 12g and ninth magnetic sensor 12i and the switching of the output of fifth magnetic sensor 12e are inverted when shift lever 4 shifts between position M and position M+ or shifts between position N and position R.

For example, when shift lever 4 is in position M or in position N, seventh magnetic sensor 12g and ninth magnetic sensor 12i face magnet 14 and fifth magnetic sensor 12e does not face magnet 14. Accordingly, at this time, seventh magnetic sensor 12g and ninth magnetic sensor 12i each output an ON signal, and fifth magnetic sensor 12e outputs an OFF signal. On the other hand, when shift lever 4 is in position M+ or in position R, seventh magnetic sensor 12g and ninth magnetic sensor 12i do not face magnet 14, and fifth magnetic sensor 12e faces magnet 14. Accordingly, at this time, seventh magnetic sensor 12g and ninth magnetic sensor 12i each output an OFF signal, and fifth magnetic sensor 12e outputs an ON signal.

In other words, when shift lever 4 shifts from position M to position M+ or shifts from position N to position R, the output of each of seventh magnetic sensor 12g and ninth magnetic sensor 12i switches from an ON signal to an OFF signal, and the output of fifth magnetic sensor 12e switches from an OFF signal to an ON signal. As described above, when shift lever 4 shifts from position M to position M+ or shifts from position N to position R, the switching of the output of each of seventh magnetic sensor 12g and ninth magnetic sensor 12i and the switching of the output of fifth magnetic sensor 12e are inverted.

In addition, when shift lever 4 shifts from position M+ to position M and shifts from position R to position N, the output of each of seventh magnetic sensor 12g and ninth magnetic sensor 12i switches from an OFF signal to an ON signal, and the output of fifth magnetic sensor 12e switches from an ON signal to an OFF signal. As described above, when shift lever 4 shifts from position M+ to position M or shifts from position R to position N, the switching of the output of each of seventh magnetic sensor 12g and ninth magnetic sensor 12i and the switching of the output of fifth magnetic sensor 12e are inverted.

It should be noted that, when shift lever 4 is in position M or in position M+, first, third, fourth, and sixth magnetic sensors 12a, 12c, 12d, and 12f face magnet 14, and each output an ON signal. In other words, when shift lever 4 shifts between position M and position M+, the outputs of first, third, fourth, and sixth magnetic sensors 12a, 12c, 12d, and 12f do not switch.

In addition, when shift lever 4 is in position M or in position M+, second and eighth magnetic sensors 12b and 12h do not face magnet 14, and each output an OFF signal. In other words, when shift lever 4 shifts between position M and position M+, the outputs of second and eighth magnetic sensors 12b and 12h do not switch.

In addition, when shift lever 4 is in position N or in position R, second, fourth, and sixth magnetic sensors 12b, 12d, and 12f face magnet 14, and each output an ON signal. In other words, when shift lever 4 shifts between position N and position R, the outputs of second, fourth, and sixth magnetic sensors 12b, 12d, and 12f do not switch.

In addition, when shift lever 4 is in position N or in position R, first, third, and eighth magnetic sensors 12a, 12c, and 12h do not face magnet 14, and each output an OFF signal. In other words, when shift lever 4 shifts between position N and position R, the outputs of first, third, and eighth magnetic sensors 12a, 12c, and 12h do not switch.

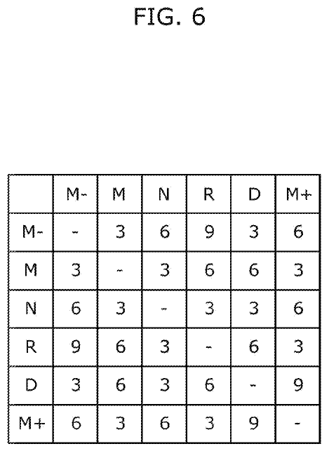

FIG. 6 is a table indicating the hamming distance between a plurality of positions. The hamming distance is a total number of different bits in two code words that are compared. When the hamming distance between any two code words is greater than or equal to t+1, it is possible to detect up to t errors in a code word, and when it is greater than or equal to 2t+1, it is possible to correct up to t errors in a code word.

As illustrated in FIG. 6, for example, the hamming distance between the code word which is the combination of signals output from first to ninth magnetic sensors 12a to 12i when shift lever 4 is in position M, and the code word which is the combination of signals output from first to ninth magnetic sensors 12a to 12i when shift lever 4 is in position M− is “3”. In position detection device 10, a hamming distance of “3” is ensured at minimum. Accordingly, for error detection, t=2 is obtained, and up to two errors in output can be detected. In addition, for error detection, t=1 is obtained, and up to one error in output can be corrected.

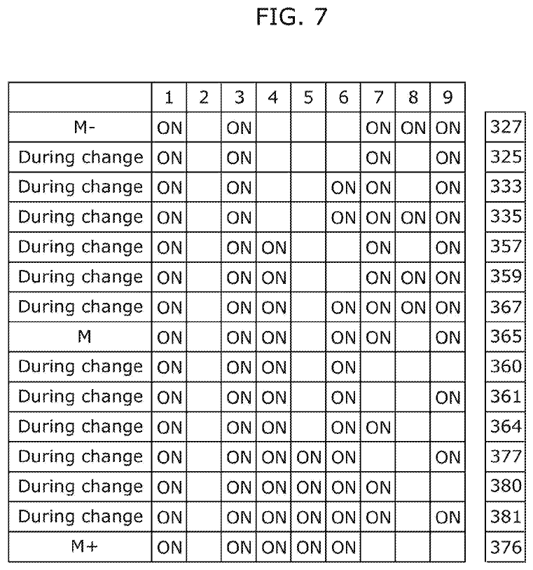

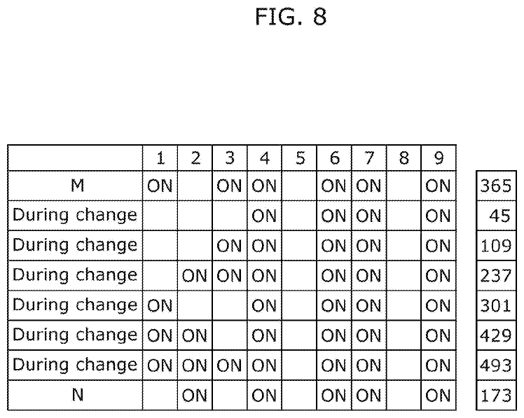

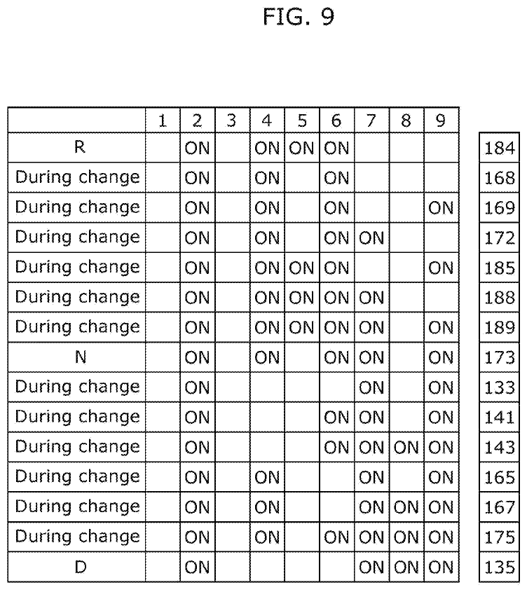

FIG. 7 is a table indicating the signals that can be output by first to ninth magnetic sensors 12a to 12i of position detection device 10 illustrated in FIG. 1 when shift lever 4 is positioned somewhere in between position M and position M+, and is positioned somewhere in between position M and position M−. FIG. 8 is a table indicating the signals that can be output by first to ninth magnetic sensors 12a to 12i of position detection device illustrated in FIG. 1 when shift lever 4 is positioned somewhere in between position M and position N. FIG. 9 is a table indicating the signals that can be output by first to ninth magnetic sensors 12a to 12i of position detection device 10 illustrated in FIG. 1 when shift lever 4 is positioned somewhere in between position N and position D, and is positioned somewhere in between position N and position R. It should be noted that, in FIG. 7, FIG. 8, and FIG. 9, the sequence of signals output by first to ninth magnetic sensors 12a to 12i is considered to be a 9-bit binary number, and the values obtained by converting this to decimal numbers are indicated on the right side.

As illustrated in FIG. 7, for example, when shift lever 4 shifts from position M to position M−, the outputs of fourth and sixth magnetic sensors 12d and 12f each switch from an ON signal to an OFF signal, the output of eighth magnetic sensor 12h switches from an OFF signal to an ON signal, and the outputs of first, second, third, fifth, seventh, and ninth magnetic sensors 12a, 12b, 12c, 12e, 12g, and 12i do not switch.

As a result, there are six possible patterns in the combination of signals that can be output by first to ninth magnetic sensors 12a to 12i in the process of shifting of shift lever 4 between position M and position M−.

In addition, there are six possible patterns in the combination of signals that can be output by first to ninth magnetic sensors 12a to 12i in the process of shifting of shift lever 4 between position M and position M+ as well.

As illustrated in FIG. 8, there are six possible patterns in the combination of signals that can be output by first to ninth magnetic sensors 12a to 12i in the process of shifting of shift lever 4 between position M and position N as well.

As illustrated in FIG. 9, there are six possible patterns in the combination of signals that can be output by first to ninth magnetic sensors 12a to 12i in each of the process of shifting of shift lever 4 between position N and position D and the process of shifting of shift lever 4 between position N and position R as well.

The patterns described above are all different from one another. As a result, in any cases of shifting of shift lever 4 between arbitrary two positions among six positions of position M, position N, position M−, position D, position R, and position M+, it is possible to identify the current position of shift lever 4. Accordingly, it is possible to inhibit occurrence of a false detection.

Position detection device 10 according to the present embodiment has been described so far.

Position detection device 10 according to the present embodiment is a position detection device that detects a position of shift lever 4 that is shiftable: from position M to position N and position M− located in two mutually different directions; and from position N to position M, position D, and position R located in three mutually different directions. Position detection device 10 includes: magnet 14; and first to ninth magnetic sensors 12a to 12i each of which outputs a first type of signal or a second type of signal according to a positional relationship with magnet 14. In position detection device 10, magnet 14 shifts with respect to first to ninth magnetic sensors 12a to 12i according to the shifting of shift lever 4. First to ninth magnetic sensors 12a to 12i include: first to third magnetic sensors 12a to 12c; fourth, sixth, and eighth magnetic sensors 12d, 12f, and 12h; and fifth, seventh, and ninth magnetic sensors 12e, 12g, and 12i. An output of each of first to third magnetic sensors 12a to 12c switches when shift lever 4 shifts between position M and position N. An output of each of fourth, sixth, and eighth magnetic sensors 12d, 12f, and 12h switches when shift lever 4 shifts between position M and position M− or between position N and position D. An output of each of fifth, seventh, and ninth magnetic sensors 12e, 12g, and 12i switches when shift lever 4 shifts between position N and position R. Position detection device 10 satisfies the following (i) to (iii): (i) first to third magnetic sensors 12a to 12c are arranged such that switching of outputs of first and third magnetic sensors 12a and 12c out of first to third magnetic sensors 12a to 12c and switching of an output of second magnetic sensor 12b that is a remaining one of first to third magnetic sensors 12a to 12c are inverted when shift lever 4 shifts between position M and position N; (ii) fourth, sixth, and eighth magnetic sensors 12d, 12f, and 12h are arranged such that switching of outputs of fourth and sixth magnetic sensors 12d and 12f out of fourth, sixth, and eighth magnetic sensors 12d, 12f, and 12h and switching of an output of eighth magnetic sensors 12h that is a remaining one of fourth, sixth, and eighth magnetic sensors 12d, 12f, and 12h are inverted when shift lever 4 shifts between position M and position M− or between position N and position D; and (iii) fifth, seventh, and ninth magnetic sensors 12e, 12g, and 12 are arranged such that switching of outputs of seventh and ninth magnetic sensors 12g and 12i out of fifth, seventh, and ninth magnetic sensors 12e, 12g, and 12i and switching of an output of fifth magnetic sensor 12e that is a remaining one of fifth, seventh, and ninth magnetic sensors 12e, 12g, and 12i are inverted when shift lever 4 shifts between position N and position R.

According to the above-described configuration, with: first to third magnetic sensors 12a to 12c an output of each of which switches when shift lever 4 shifts between position M and position N; fourth, sixth, and eighth magnetic sensors 12d, 12f, and 12h an output of each of which switches when shift lever 4 shifts between position M and position M− or shifts between position N and position D; and fifth, seventh, and ninth magnetic sensors 12e, 12g, and 12i an output of each of which switches when shift lever 4 shifts between position N and position R, it is possible to inhibit the combination of signals output by first to ninth magnetic sensors 12a to 12i from becoming the same in spite of the fact that shift lever 4 is located at different positions. Accordingly, it is possible to inhibit the occurrence of false detections. In addition, since the switching of the outputs of first and third magnetic sensors 12a and 12c and the switching of the output of second magnetic sensor 12b are inverted, it is not necessary to arrange first to third magnetic sensors 12a to 12c to be aligned in one direction, and thus it is possible to inhibit magnet 14 from being large in the one direction. As a result, position detection device 10 can be easily downsized. In addition, since the switching of the outputs of fourth and sixth magnetic sensors 12d and 12f and the switching of the output of eighth magnetic sensor 12h are inverted, it is not necessary to arrange fourth, sixth, and eighth magnetic sensors 12d, 12f, and 12h to be aligned in one direction, and thus it is possible to inhibit magnet 14 from being large in the one direction. As a result, position detection device 10 can be easily downsized. In addition, since the switching of the outputs of seventh and ninth magnetic sensors 12g and 12i and the switching of the output of fifth magnetic sensor 12e are inverted, it is not necessary to arrange fifth, seventh, and ninth magnetic sensors 12e, 12g, and 12i to be aligned in one direction, and thus it is possible to inhibit magnet 14 from being large in the one direction. As a result, position detection device 10 can be easily downsized.

In addition, in position detection device 10 according to the present embodiment, first and third magnetic sensors 12a and 12c are disposed side by side in the front-back direction that is perpendicular to a direction from position M to position N, and second magnetic sensors 12b is disposed at a position different from first and third magnetic sensors 12a and 12c in the right-left direction that is parallel to the direction from position M to position N.

According to the above-described configuration, second magnetic sensor 12b is disposed at a position different from first and third magnetic sensors 12a and 12c in the right-left direction, and thus it is possible to inhibit first to third magnetic sensors 12a to 12c from being aligned in the front-back direction, which makes it possible to inhibit magnet 14 from being large in the front-back direction. As a result, position detection device 10 can be easily downsized.

In addition, in position detection device 10 according to the present embodiment, second magnetic sensors 12b is aligned with third magnetic sensor 12c in the right-left direction.

According to the above-described configuration, it is possible to inhibit second magnetic sensor 12b from being located forward of or behind first and third magnetic sensors 12a and 12c, and thus it is possible to inhibit magnet 14 from being large in the front-back direction. As a result, position detection device 10 can be easily downsized.

In addition, in position detection device 10 according to the present embodiment, fourth, sixth, and eighth magnetic sensors 12d, 12f, and 12h and the fifth, seventh, and ninth magnetic sensors 12e, 12g, and 12i are disposed, in the right-left direction: closer to second magnetic sensors 12b than first and third magnetic sensors 12a and 12c are; and closer to first and third magnetic sensors 12a and 12c than second magnetic sensor 12b is.

According to the above-described configuration, it is possible to inhibit fourth, sixth, and eighth magnetic sensors 12d, 12f, and 12h and fifth, seventh, and ninth magnetic sensors 12e, 12g, and 12i from being located, in the right-left direction, on the opposite side of second magnetic sensor 12b with respect to first and third magnetic sensors 12a and 12c; that is, to the left of first and third magnetic sensors 12a and 12c, and to inhibit fourth, sixth, and eighth magnetic sensors 12d, 12f, and 12h and fifth, seventh, and ninth magnetic sensors 12e, 12g, and 12i from being located, in the right-left direction, on the opposite side of first and third magnetic sensors 12a and 12c with respect to second magnetic sensor 12b; that is, to the right of second magnetic sensor 12b. In this manner, it is possible to inhibit magnet 14 from being large in the right-left direction. As a result, position detection device 10 can be easily downsized.

In addition, in position detection device 10 according to the present embodiment, a direction from position M to position M− and a direction from position N to position D are identical to each other and parallel to the front-back direction, fourth and sixth magnetic sensors 12d and 12f are disposed side by side in the right-left direction, eighth magnetic sensor 12h is disposed at a position different from fourth and sixth magnetic sensors 12d and 12f in the front-back direction, and first to third magnetic sensors 12a to 12c are disposed, in the front-back direction: closer to eighth magnetic sensor 12h than fourth and sixth magnetic sensors 12d and 12f are, and closer to fourth and sixth magnetic sensors 12d and 12f than eighth magnetic sensor 12h is.

According to the above-described configuration, eighth magnetic sensor 12h is located at a position different from fourth and sixth magnetic sensors 12d and 12f in the front-back direction, and thus it is possible to inhibit fourth, sixth, and eighth magnetic sensors 12d, 12f, and 12h from being aligned in the right-left direction. As a result, it is possible to inhibit magnet 14 from being large in the right-left direction. In addition, it is possible to inhibit first to third magnetic sensors 12a to 12c from being located, in the front-back direction, on the opposite side of eighth magnetic sensor 12h with respect to fourth and sixth magnetic sensors 12d and 12f; that is, forward of fourth and sixth magnetic sensors 12d and 12f, and to inhibit first to third magnetic sensors 12a to 12c from being located, in the front-back direction, on the opposite side of fourth and sixth magnetic sensors 12d and 12f with respect to eighth magnetic sensor 12h; that is, behind eighth magnetic sensor 12h. In this manner, it is possible to inhibit magnet 14 from being large in the front-back direction. As a result, position detection device 10 can be easily downsized.

In addition, in position detection device 10 according to the present embodiment, eighth magnetic sensor 12h is aligned with sixth magnetic sensor 12f in the front-back direction.

According to the above-described configuration, it is possible to inhibit eighth magnetic sensor 12h from being located to the left or to the right of the set of fourth and sixth magnetic sensors 12d and 12f. In this manner, it is possible to inhibit magnet 14 from being large in the right-left direction. As a result, position detection device 10 can be easily downsized.

In addition, in position detection device 10 according to the present embodiment, direction from position N to position R is opposite to the direction from position N to position D, seventh and ninth magnetic sensors 12g and 12i are disposed side by side in the right-left direction, fifth magnetic sensor 12e is disposed at a position different from seventh and ninth magnetic sensors 12g and 12i, and first to third magnetic sensors 12a to 12c are disposed, in the front-back direction: closer to fifth magnetic sensor 12e than seventh and ninth magnetic sensors 12g and 12i are, and closer to seventh and ninth magnetic sensors 12g and 12i than fifth magnetic sensor 12e is.

According to the above-described configuration, fifth magnetic sensor 12e is located at a position different from seventh and ninth magnetic sensors 12g and 12i in the front-back direction, and thus it is possible to inhibit fifth, seventh, and ninth magnetic sensors 12e, 12g, and 12i from being aligned in the right-left direction. In this manner, it is possible to inhibit magnet 14 from being large in the right-left direction. As a result, position detection device 10 can be easily downsized. In addition, it is possible to inhibit first to third magnetic sensors 12a to 12c from being located, in the front-back direction, on the opposite side of fifth magnetic sensor 12e with respect to seventh and ninth magnetic sensors 12g and 12i; that is, behind seventh and ninth magnetic sensors 12g and 12i, and to inhibit first to third magnetic sensors 12a to 12c from being located, in the front-back direction, on the opposite side of seventh and ninth magnetic sensors 12g and 12i with respect to fifth magnetic sensor 12e; that is, forward of fifth magnetic sensor 12e. In this manner, it is possible to inhibit magnet 14 from being large in the front-back direction. As a result, position detection device 10 can be easily downsized.

In addition, in position detection device 10 according to the present embodiment, seventh and ninth magnetic sensors 12g and 12i are aligned with fourth and sixth magnetic sensors 12d and 12f in the front-back direction, and fifth magnetic sensor 12e is aligned with: sixth magnetic sensor 12f; ninth magnetic sensor 12i; and eighth magnetic sensor 12h, in the front-back direction.

According to the above-described configuration, it is possible to inhibit the set of seventh and ninth magnetic sensors 12g and 12i from being located to the left or to the right of the set of fourth and sixth magnetic sensors 12d and 12f. In this manner, it is possible to inhibit magnet 14 from being large in the right-left direction. As a result, position detection device 10 can be easily downsized. In addition, it is possible to inhibit fifth magnetic sensor 12e from being located to the left or to the right of the set of fourth and sixth magnetic sensors 12d and 12f, the set of seventh and ninth magnetic sensors 12g and 12i, and eighth magnetic sensor 12h. In this manner, it is possible to inhibit magnet 14 from being large in the right-left direction. As a result, position detection device 10 can be easily downsized.

In addition, in position detection device 10 according to the present embodiment, shift lever 4 is shiftable from position M to position M+ located in a direction different from position N and different from position M−, a direction from position M to position M+ is opposite to the direction from position M to position M−, and fifth, seventh, and ninth magnetic sensors 12e, 12g, and 12i are arranged such that the switching of the outputs of seventh and ninth magnetic sensors 12g and 12i and the switching of the output of fifth magnetic sensor 12e are inverted when shift lever 4 shifts between position M and the position M+.

According to the above-described configuration, it is not necessary to arrange fifth, seventh, and ninth magnetic sensors 12e, 12g, and 12i to be aligned in one direction, and thus it is possible to inhibit magnet 14 from being large in the one direction. As a result, position detection device 10 can be easily downsized.

### Other Embodiments, Etc.

Although the position detection device according to one or more aspects has been described above based on the embodiment, the present disclosure is not limited to the above-described embodiment. Variations of the embodiment conceivable by those skilled in the art may be included within the scope of the present disclosure as long as they do not depart from the novel teachings and advantages of the present disclosure.

In the above-described embodiment, the case where shifting device 1 is a so-called H-shaped shifting device has been described, but the present disclosure is not limited to this case. For example, the shifting device may be a so-called h-shaped shifting device in which position M+ is not provided.

In addition, in the above-described embodiment, the case where magnet 14 shifts with respect to first to ninth magnetic sensors 12a to 12i according to the shifting of shift lever 4 has been described, but the present disclosure is not limited to this case. For example, first to ninth magnetic sensors 12a to 12i may shift with respect to magnet 14 according to the shifting of shift lever 4.

In addition, in the above-described embodiment, the case where (i) to (iii) are satisfied has been described, but the present disclosure is not limited to this case. For example, only (i) among the above-described (i) to (iii) may be satisfied. In this case, for example, fourth, sixth, and eighth magnetic sensors 12d, 12f, and 12h may be aligned in the right-left direction, and fifth, seventh, and ninth magnetic sensors 12e, 12g, and 12i may be aligned in the right-left direction. In addition, for example, only (ii) among the above-described (i) to (iii) may be satisfied. In this case, for example, first to third magnetic sensors 12a to 12c may be aligned in the front-back direction, and fifth, seventh, and ninth magnetic sensors 12e, 12g, and 12i may be aligned in the right-left direction. In addition, for example, only (iii) among the above-described (i) to (iii) may be satisfied. In this case, for example, first to third magnetic sensors 12a to 12c may be aligned in the front-back direction, and fourth, sixth, and eighth magnetic sensors 12d, 12f, and 12h may be aligned in the right-left direction. In addition, for example, only two out of the above-described (i) to (iii) may be satisfied.

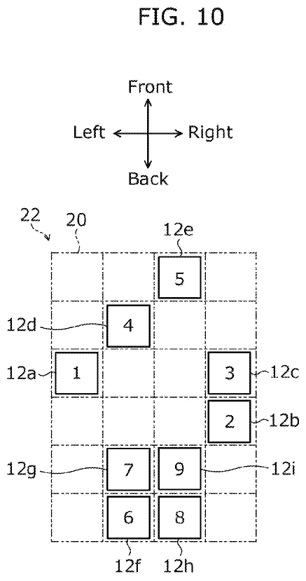

In addition, in the above-described embodiment, the example of the arrangement of first to ninth magnetic sensors 12a to 12i has been illustrated in FIG. 3, but other arrangements that satisfy the above-described (i) to (iii) may be employed. For example, first to ninth magnetic sensors 12a to 12i may be arranged as illustrated in FIG. 10. In FIG. 10, compared to FIG. 3, sixth magnetic sensor 12f is located behind seventh magnetic sensor 12g and to the left of eighth magnetic sensor 12h. In addition, third magnetic sensor 12c is located in front of second magnetic sensor 12b and to the right of first magnetic sensor 12a.

In this case, when shift lever 4 shifts from position M to position N, the output of first magnetic sensor 12a switches from an ON signal to an OFF signal, and the output of each of second magnetic sensor 12b and third magnetic sensor 12c switches from an OFF signal to an ON signal. As described above, when shift lever 4 shifts from position M to position N, the switching of the output of first magnetic sensor 12a and the switching of the output of each of second magnetic sensor 12b and third magnetic sensor 12c are inverted.

In addition, when shift lever 4 shifts from position M to position M− or shifts from position N to position D, the output of fourth magnetic sensor 12d switches from an ON signal to an OFF signal, and the output of each of sixth magnetic sensor 12f and eighth magnetic sensor 12h switches from an OFF signal to an ON signal. As described above, when shift lever 4 shifts from position M to position M− or shifts from position N to position D, the switching of the output of fourth magnetic sensor 12d and the switching of the output of each of sixth magnetic sensor 12f and eighth magnetic sensor 12h are inverted.

In addition, in above-described embodiment, the case where position detection device 10 is arranged such that the front-back direction corresponds to the perpendicular direction and the right-left direction corresponds to the parallel direction, but the present disclosure is not limited to this case. For example, position detection device 10 may be arranged such that the front-back direction corresponds to the parallel direction and the right-left direction corresponds to the perpendicular direction.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2021-049763 filed on Mar. 24, 2021, and PCT International Application No. PCT/JP2021/042360 filed on Nov. 18, 2021.

### INDUSTRIAL APPLICABILITY

The present disclosure is applicable to a position detection device, etc. that detect a position of an operable portion such as a shift lever.

1. A position detection device that detects a position of an operable portion that is shiftable: from a first position to a second position and a third position located in two mutually different directions; and from the second position to the first position, a fourth position, and a fifth position located in three mutually different directions, the position detection device comprising:
a detection object; and
a plurality of detectors each of which outputs a first type of signal or a second type of signal according to a positional relationship with the detection object, wherein
according to shifting of the operable portion: the detection object shifts with respect to the plurality of detectors; the plurality of detectors shift with respect to the detection object; or the detection object shifts with respect to the plurality of detectors and the plurality of detectors shift with respect to the detection object,
the plurality of detectors include: three first detectors; three second detectors; and three third detectors,
an output of each of the three first detectors switches when the operable portion shifts between the first position and the second position, an output of each of the three second detectors switches when the operable portion shifts between the first position and the third position or between the second position and the fourth position, and an output of each of the three third detectors switches when the operable portion shifts between the second position and the fifth position, and
at least one of the following (i) to (iii) is satisfied:
(i) switching of outputs of two of the three first detectors and switching of an output of a remaining one of the three first detectors are inverted when the operable portion shifts between the first position and the second position;
(ii) switching of outputs of two of the three second detectors and switching of an output of a remaining one of the three second detectors are inverted when the operable portion shifts between the first position and the third position or between the second position and the fourth position; and
(iii) switching of outputs of two of the three third detectors and switching of an output of a remaining one of the three third detectors are inverted when the operable portion shifts between the second position and the fifth position.

2. The position detection device according to claim 1, wherein
(i) is satisfied,
the two of the three first detectors are disposed side by side in a perpendicular direction that is perpendicular to a direction from the first position to the second position, and
the remaining one of the three first detectors is disposed at a position different from the two of the three first detectors in a parallel direction that is parallel to the direction from the first position to the second position.

3. The position detection device according to claim 2, wherein
the remaining one of the three first detectors is aligned with one of the two of the three first detectors in the parallel direction.

4. The position detection device according to claim 2, wherein
the three second detectors and the three third detectors are disposed, in the parallel direction: closer to the remaining one of the three first detectors than the two of the three first detectors are; and closer to the two of the three first detectors than the remaining one of the three first detectors is.

5. The position detection device according to claim 4, wherein
(ii) is satisfied,
a direction from the first position to the third position and a direction from the second position to the fourth position are identical to each other and parallel to the perpendicular direction,
the two of the three second detectors are disposed side by side in the parallel direction,
the remaining one of the three second detectors is disposed at a position different from the two of the three second detectors in the perpendicular direction, and
the three first detectors are disposed, in the perpendicular direction: closer to the remaining one of the three second detectors than the two of the three second detectors are, and closer to the two of the three second detectors than the remaining one of the three second detectors is.

6. The position detection device according to claim 5, wherein
the remaining one of three second detectors is aligned with one of the two of the three second detectors in the perpendicular direction.

7. The position detection device according to claim 5, wherein
(iii) is satisfied,
a direction from the second position to the fifth position is opposite to the direction from the second position to the fourth position,
the two of the three third detectors are disposed side by side in the parallel direction,
the remaining one of the three third detectors is disposed at a position different from the two of the three third detectors, and
the three first detectors are disposed, in the perpendicular direction: closer to the remaining one of the three third detectors than the two of the three third detectors are, and closer to the two of the three third detectors than the remaining one of the three third detectors is.

8. The position detection device according to claim 7, wherein
the two of the three third detectors are aligned with the two of the three second detectors in the perpendicular direction, and
the remaining one of three third detectors is aligned with: one of the two of the three second detectors; one of the two of the three third detectors; and the remaining one of the three second detectors, in the perpendicular direction.

9. The position detection device according to claim 7, wherein
the operable portion is shiftable from the first position to a sixth position located in a direction different from the second position and different from the third position,
a direction from the first position to the sixth position is opposite to the direction from the first position to the third position, and
the switching of the outputs of the two of the three third detectors and the switching of the output of the remaining one of the three third detectors are inverted when the operable portion shifts between the first position and the sixth position.
